(19) United States
(12) Patent Application Publication
(10) Pub. No.: US 2018/0330688 A1
(43) Pub. Date: Nov. 15, 2018

(54) Driving Signal Compensation Method and Driving Signal Compensation Device

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Sikun HAO, Shenzhen (CN)

(73) Assignee: Shenzhen China Star Optoelectronics Semiconductor Display Technology Co., Ltd., Shenzhen, Guangdong (CN)

(21) Appl. No.: 15/572,567

(22) PCT Filed: Jun. 9, 2017
(86) PCT No.: PCT/CN2017/087794

§ 371 Date: Nov. 8, 2017

(30) Foreign Application Priority Data
May 10, 2017 (CN) 201710326101.1

(51) Int. Cl. G09G 3/36

(52) U.S. Cl. CPC G09G 3/3677; G09G 3/3688; G09G 2310/06; G09G 2320/0295; G09G 2310/08; G09G 2320/0223

(57) ABSTRACT

The present disclosure provides a driving signal compensation method and a driving signal compensation device. The driving signal compensation method includes: obtaining a first phase difference between an output scan signal and an output data signal of each pixel, and adjusting a phase of an input scan signal of or a phase of an input data signal of the pixel according to the first phase difference, to equalize the first a phase difference between the output scan signal and the output data signal of the pixel and a phase difference between the input scan signal and the input data signal of the pixel.

### BACKGROUND OF THE INVENTION

### 1. Field of the Invention

The present disclosure relates to the field of display technology, and more particularly to a driving signal compensation method and a driving signal compensation device.

### 2. Description of the Prior Art

Liquid crystal displays (LCDs) are currently widely used flat panel displays, and are used in various electronic equipment, such as mobile phones, personal digital assistants (PDAs), digital cameras, computer screens, or notebook computer screens. Generally, the LCDs include an up substrate, a down substrate, and a liquid crystal layer. The up and down substrates include glass and electrodes. When the electrodes are arranged on the up and down substrates, a longitudinal electric field display forms, such as a twist nematic (TN) mode, a vertical alignment mode, and a multi-domain vertical alignment (MVA) mode, to solve the narrow viewing angle issue. When the electrodes are only arranged on one of the up substrate and the down substrate, a transverse electric field display forms, such as a in-plane switching mode, and a fringe field switching mode.

FIG. 1 is a waveform diagram of a driving signal of an LCD panel according to the prior art. G1-G6 show oscillograms of the signal on the scan line, and D1-D6 show oscillograms of the signal on the data line. Pixels arranged on an upper-left portion of the LCD are closer to a gate driving chip and a source driving chip, therefore there is less delay of the scan signal and data signal. Pixels arranged on a middle-left portion of the LCD are far from the gate driving chip and the source driving chip, therefore, there is a greater delay of the scan signal and less delay of the data signal. Delay of the scan signal and data signal of pixels arranged on other portions of the LCD is similar.

FIG. 2 is a waveform diagram of a scan signal and a data signal of pixels of an upper-left portion of the LCD panel. 101 represents the scan signal, 102 represents the data signal, P1 represents a pulse of the scan signal, and P2 represents a pulse of the data signal. As there is less delay of the scan signal and the data signal of the pixels arranged on the upper-left portion of the LCD, when the data signal switches, namely at t0, the scan signal is at a low level (dashed box as shown in FIG. 2), namely a thin film transistor (TFT) on the scan line turns off, thereby not causing a false charging issue. FIG. 3 is a waveform diagram of a scan signal and a data signal of pixels of a middle-left portion of the LCD panel. As there is a greater delay of the scan signal and the data signal of the pixels arranged on the upper-middle portion of the LCD, when the data signal switches, namely at t1, the scan signal is not at a low level (dashed box as shown in FIG. 3), namely the TFT on the scan line does not completely turn off, further causing a false charging issue and affecting display.

Therefore, it is necessary to provide a driving signal compensation method and a driving signal compensation device to solve the existing issue in prior art.

### SUMMARY OF THE INVENTION

The aim of the present disclosure is to provide a driving signal compensation method and a driving signal compensation device capable of improving display.

In order to solve the above technical problem, the present disclosure provides a driving signal compensation method, where the driving signal compensation method comprises:
obtaining a first phase difference between an output scan signal and an output data signal of each pixel;
obtaining a difference value between the first phase difference and an initial phase difference of each pixel; the initial phase difference is a phase difference between an input scan signal and an input data signal of the pixel;.
adjusting a phase of the input scan signal or a phase of the input data signal of the pixel according to the difference value to equalize the first phase difference between the output scan signal and the output data signal of the pixel and the initial phase difference between the input scan signal and the input data signal of the pixel;
when a liquid crystal display (LCD) panel comprises a gate driver chip, adjusting the phase of the input scan signal or the phase of the input data signal of the pixel that is at a distance from the gate driver chip greater than a predetermined distance.

In the driving signal compensation method, the step of adjusting the phase of the input scan signal of the pixel according to the difference value further comprises:
decreasing the phase of the input scan signal of the pixel by the difference value when the first phase difference is greater than the initial phase difference.

In the driving signal compensation method, the phase of the input scan signal of the pixel is decreased by the difference value, to equalize a phase difference along a vertical direction between the output scan signal and the output data signal of each pixel and a phase difference along the vertical direction between the input scan signal and the input data signal of the pixel.

In the driving signal compensation method, the step of adjusting the phase of the input data signal of the pixel according to the difference value further comprises:
adding the difference value to the phase of the input data signal of the pixel when the first phase difference is greater than the initial phase difference.

In the driving signal compensation method, the difference value is added to the phase of the input data signal of the pixel, to equalize a phase difference along a horizontal direction between the output scan signal and the output data signal of each pixel and a phase difference along the horizontal direction between the input scan signal and the input data signal of the pixel.

In the driving signal compensation method of the present disclosure, the step of adjusting the phase of the input data signal of the pixel according to the difference value further comprises:
adding a predetermined phase to the phase of the input data signal of each pixel.

In the driving signal compensation method of the present disclosure, when the LCD panel comprises a first gate driver chip and a second gate driver chip opposite the first gate driver chip, the phase of the input scan signal of the pixel or the phase of the input data signal of the pixel that is at distances from the first gate driver chip and the second gate driver chip greater than the predetermined distance is adjusted.

In order to solve the above technical problem, the present disclosure further provides a driving signal compensation method, where the driving signal compensation method comprises:
obtaining a first phase difference between an output scan signal and an output data signal of each pixel;
adjusting a phase of an input scan signal of or a phase of an input data signal of the pixel according to the first phase difference, to equalize the first a phase difference between the output scan signal and the output data signal of the pixel and a phase difference between the input scan signal and the input data signal of the pixel.

In the driving signal compensation method of the present disclosure, the step of adjusting the phase of the input scan signal or the phase of the input data signal of the pixel according to the first phase difference further comprises:
obtaining a difference value between the first phase difference and an initial phase difference of each pixel, wherein the initial phase difference is a phase difference between the input scan signal and the input data signal of the pixel;
adjusting the phase of the input scan signal or the phase of the input data signal of the pixel according to the difference value.

In the driving signal compensation method of the present disclosure, the step of adjusting the phase of the input scan signal of the pixel according to the difference value further comprises:
decreasing the phase of the input scan signal of the pixel by the difference value when the first phase difference is greater than the initial phase difference.

In the driving signal compensation method of the present disclosure, the phase of the input scan signal of the pixel is decreased by the difference value, to equalize a phase difference along a vertical direction between the output scan signal
and the output data signal of each pixel and a phase difference along the vertical direction between the input scan signal and the input data signal of the pixel.

In the driving signal compensation method of the present disclosure, the step of adjusting the phase of the input data signal of the pixel according to the difference value further comprises:

adding the difference value to the phase of the input data signal of the pixel when the first phase difference is greater than the initial phase difference.

In the driving signal compensation method of the present disclosure, the difference value is added to the phase of the input data signal of the pixel, to equalize a phase difference along a horizontal direction between the adjusted output scan signal and the output data signal of each pixel and a phase difference along the horizontal direction between the adjusted input scan signal and the input data signal of the pixel.

In the driving signal compensation method of the present disclosure, the step of adjusting the phase of the input data signal of the pixel according to the difference value further comprises:
adding a predetermined phase to the phase of the input data signal of each pixel.

In the driving signal compensation method of the present disclosure, when an LCD panel comprises a gate driver chip, the phase of the input scan signal or the phase of the input data signal of the pixel that is at a distance from the gate driver chip greater than a predetermined distance is adjusted.

In the driving signal compensation method of the present disclosure, when the LCD panel comprises a first gate driver chip and a second gate driver chip opposite the first gate driver chip, the phase of the input scan signal of the pixel or the phase of the input data signal of the pixel that is at distances from the first gate driver chip and the second gate driver chip greater than the predetermined distance is adjusted.

The present disclosure provides a driving signal compensation device, where the driving signal compensation device comprises:
an obtaining module obtaining a first phase difference between an output scan signal and an output data signal of each pixel; and
an adjusting module adjusting a phase of an input scan signal or a phase of an input data signal of the pixel according to the first phase difference, to equalize the first phase difference between the output scan signal and the output data signal of the pixel and a phase difference between the input scan signal and the input data signal of the pixel.

In the driving signal compensation device of the present disclosure, the adjusting module comprises an obtaining unit and an adjusting unit, where the obtaining unit obtains a difference value between the first phase difference and an initial phase difference of each pixel, and the initial phase difference is a phase difference between the input scan signal and the input data signal of the pixel. The adjusting unit adjusts the phase of the input scan signal or the phase of the input data signal of the pixel according to the difference value.

In the driving signal compensation device of the present disclosure, the adjusting unit is configured to decrease the phase of the input scan signal of the pixel by the difference value when the first phase difference is greater than the initial phase difference.

In the driving signal compensation device of the present disclosure, the adjusting unit is configured to add the difference value to the phase of the input data signal of the pixel when the first phase difference is greater than the initial phase difference.

The driving signal compensation method and the driving signal compensation device of the present disclosure are used to adjust the phases of the input scan signal and the input data signal of the pixels at different positions on the LCD panel, when the data signal switches during an actual driving process, the scan line completely turns off, further avoiding a false charging issue and improving the display.

### BRIEF DESCRIPTION OF THE DRAWINGS

FIG. 1 is a waveform diagram of a driving signal of a liquid crystal display (LCD) panel according to the prior art.

FIG. 2 is a waveform diagram of a scan signal and a data signal of pixels of an upper-left portion of the LCD panel.

FIG. 3 is a waveform diagram of a scan signal and a data signal of pixels of a middle-left portion of the LCD panel.

FIG. 4 is a waveform diagram of a scan signal and a data signal of single-pixel of the LCD panel without adjustment.

FIG. 5 is a waveform diagram of a scan signal and a data signal of pixels in a first row of a first LCD panel after adjustment.

FIG. 6 is a waveform diagram of a scan signal and a data signal of pixels in a first row of a second LCD panel after adjustment.

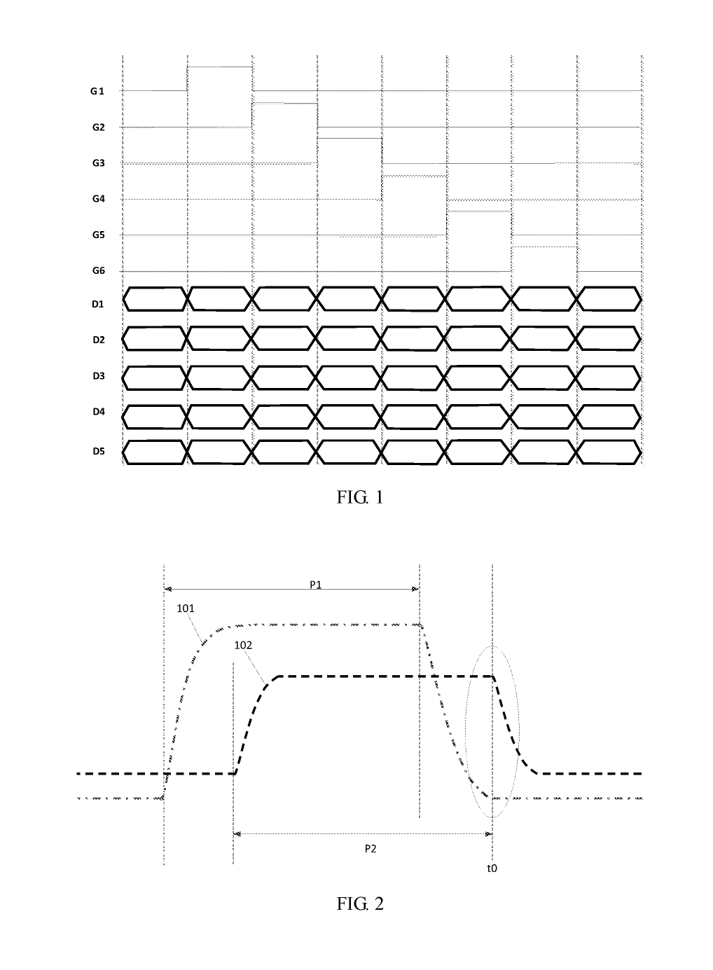

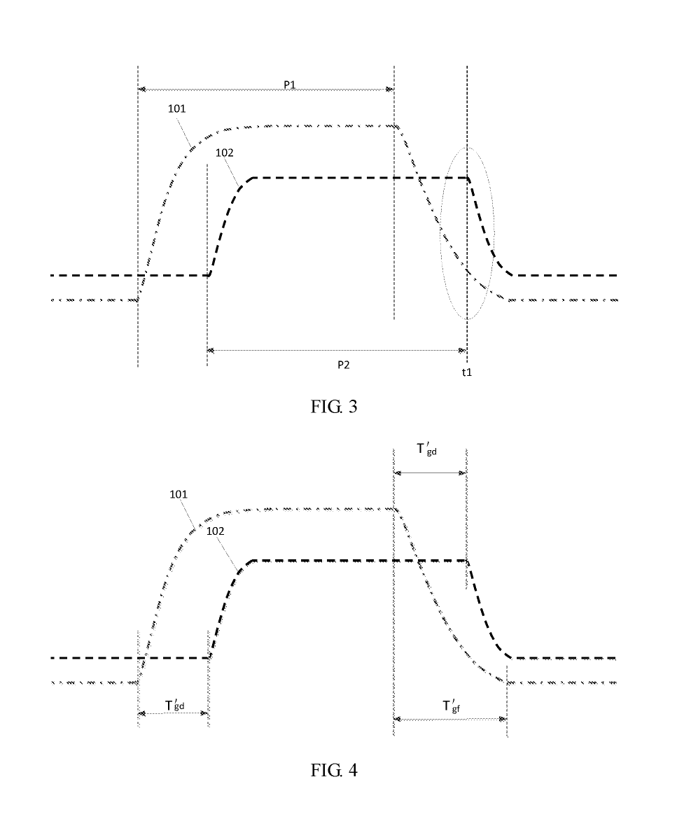

### DETAILED DESCRIPTION OF THE PREFERRED EMBODIMENTS

The description of following embodiment, with reference to the accompanying drawings, is used to exemplify specific embodiments which may be carried out in the present disclosure. Directional terms mentioned in the present disclosure, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present disclosure. In the drawings, the components having similar structures are denoted by same numerals

Referring now to FIG. 4 to FIG. 6, FIG. 4 is a waveform diagram of a scan signal and a data signal of a single pixel in a liquid crystal display (LCD) panel without adjustment.

A driving signal compensation method of the present disclosure comprises:
S101: obtaining a first phase difference between an output scan signal and an output data signal of each pixel.

For example, the scan signal and the data signal are input to the LCD panel in advance, the phase difference between a phase of an actual scan signal and a phase of an actual data signal of each pixel is obtained, namely the first phase difference. The output scan signal and the output data signal are regarded as the actual scan signal and the actual data signal of the pixel without adjustment.

S102: adjusting a phase of the input scan signal of a pixel according to the first difference value, to equalize the first phrase difference between the output scan signal and the output data signal of the pixel and a phrase difference between the input scan signal and the input data signal of the pixel.

For example, a phase of an initial scan signal of the pixel is adjusted according to the first phase difference obtained by the step 101 to equalize the first phase difference between the output scan signal and the output data signal of the pixel and a phase difference between the input scan signal and the input data signal of the pixel.

A driving chip provides a scan signal, the scan signal is regarded as the input scan signal, namely is the initial scan signal. The driving chip provides a data signal, the data signal is regarded as the input data signal, namely is the initial data signal.

When the first phrase difference between the output scan signal and the output data signal of the pixel is equal to the phase difference between the input scan signal and the input data signal of the pixel, the scan signal is at a low level to avoid a false charging problem when the data signal switches.

The step 102 comprises:
S1021: obtaining a difference value between the first phrase difference and an initial phrase difference of each pixel.

For example: a phase difference along a horizontal direction between the output scan signal and the output data signal of each pixel is obtained in advance, namely the first phase difference is obtained. Then, the difference value between the first phase difference and the initial phase difference is obtained. The initial phase difference is the phase difference between the input scan signal and the input data signal of the pixel without adjustment.

S1022: adjusting the phase of the input scan signal of the pixel in each row according to the difference value.

During the specific compensation process, the difference value between the first phase difference and the initial phase difference of each pixel is obtained, and the phase of the input scan signal of the pixel is adjusted according to the difference value. To be specific, the scan signal of the pixels in each row from left to right gradually decreases.

S103: adjusting a phase of the input data signal of the pixel according to the first difference value, to equalize the first phase difference between the output scan signal and the output data signal of the pixel and the phase difference between the input scan signal and the input data signal of the pixel.

For example, a phase of an initial data signal of the pixel is adjusted according to the first phase difference obtained by the step 101 to equalize the first phase difference between the output scan signal and the output data signal of the pixel and the phase difference between the input scan signal and the input data signal of the pixel.

The step 103 comprises:
S1031: obtaining a difference value between the first phase difference and an initial phase difference of each pixel.
S1032: adjusting the phase of the input data signal of the pixel in each row according to the difference value.

During a specific compensation process, the difference value between the first phase difference and the initial phrase difference of each pixel is obtained, and the phase of the input data signal of the pixel is adjusted according to the difference value. To be specific, the data signal of the pixels in each column from top to bottom gradually increases.

TABLE 1

| | | |
|---|---|---|
| T_{gf11} = T_{gd11} = Δ t₁₁ | T_{gf12} = T_{gd12} = Δ t₁₂ | T_{gf13} = T_{gd13} = Δ t₁₃ |
| T_{gf21} = T_{gd21} = Δ t₂₁ | T_{gf22} = T_{gd22} = Δ t₂₂ | T_{gf23} = T_{gd23} = Δ t₂₃ |
| T_{gf31} = T_{gd31} = Δ t₃₁ | T_{gf32} = T_{gd32} = Δ t₃₂ | T_{gf33} = T_{gd33} = Δ t₃₃ |

To be specific, as shown in Table 1, the LCD panel comprises nine pixels as an example, the initial phase difference is the phase difference between the initial input scan signal and the initial input data signal. T_{gf} represents an actual phase difference of each pixel after adjustment, where the actual phase difference is an actual scan signal and an actual data signal after adjustment. T_{gd} represents the initial phase difference of each pixel after adjustment, namely the phase difference is between the initial input scan signal and the initial input data signal after adjustment. T_{gd}11-T_{gd}33 represents the initial phase difference of the pixel at different positions after adjustment. T_{gf}11-T_{gf}33 represents the actual phase difference of the pixel at different positions after adjustment. T_{gf} and T_{gd} are shown in FIG. 4.

In one embodiment, when the first phase difference is greater than the initial phase difference, the phase of the input scan signal of the pixel is decreased by the difference value to equalize a phase difference along a vertical direction between the output scan signal and the output data signal of each pixel and a phase difference along the vertical direction between the input scan signal and the input data signal of each pixel.

As shown in FIG. 4, for example, T′_{gf} is greater than T′_{gd}, where T′_{gf} represents a phase difference between the actual scan signal and the actual data signal before adjustment, and T′_{gd} represents an phase difference between the initial scan signal and the initial data signal before adjustment. At this time, the phase of the initial scan signal of the pixel moves the difference value to left (the difference value=T′_{gf}-T′_{gd}) to equalize T_{gf} and T_{gd}. T_{gf}=T_{gd} after compensation, namely the phase difference between the actual scan signal and the actual data signal after adjustment is equal to the phase difference between the initial scan signal and the initial data signal after adjustment. At of different pixel can be different.

In another embodiment, when the first phase difference is greater than the initial phase difference, the difference value between the first phase difference and the initial phase difference is added to the phase of the input data signal of each pixel to equalize the phase difference along the horizontal direction between the output scan signal and output data signal of each pixel and the phase difference along the horizontal direction between the input scan signal and input data signal of each pixel.

As shown in FIG. 4, for example, T′_{gf} is greater than T′_{gd}, where T′_{gf} represents a phase difference between the actual scan signal and the actual data signal before adjustment, and T′_{gd} represents an phase difference between the initial scan signal and the initial data signal before adjustment. At this time, the phase of the initial scan signal of the pixel moves the difference value to right (the difference value=T′_{gf}-T′_{gd}) to equalize T_{gf} and T_{gd}. T_{gf}=T_{gd} after compensation, namely the phase difference between the actual scan signal and the actual data signal after adjustment is equal to the phase difference between the initial scan signal and the initial data signal after adjustment. Δt of different pixel can be different.

In another embodiment, the phase of the input data signal of each pixel is increased by a predetermined phase to equalize the phase difference along the vertical direction between the output scan signal and output data signal of each pixel and the phase difference along the vertical direction between the input scan signal and input data signal of each pixel.

For example, the input data signal of a bottom pixel in first column needs to be adjusted by a phase ml to equalize the phase difference between the actual scan signal and the actual data signal and the phase difference between the initial scan signal and the initial data signal. The input data signal of a bottom pixel in second column needs to be adjusted by a phase m2 to equalize the phase difference between the actual scan signal and the actual data signal and the phase difference between the initial scan signal and the initial data signal. The input data signal of a bottom pixel in second column needs to be adjusted by a phase m3 to equalize the phase difference between the actual scan signal and the actual data signal and the phase difference between the initial scan signal and the initial data signal. m2 is a maximum of m1, m2, and m3, and the phase of the initial data signal of each pixel moves the phrase m2, to equalize the phase difference between the actual scan signal and the actual data signal after adjustment and the phase difference between the initial scan signal and the initial data signal after adjustment. Namely, m2 is a predetermined phase.

In one embodiment, when the LCD panel comprises a gate driver chip, namely the LCD panel is a signal-drive LCD panel, the phase of the input scan signal or the phase of the input data signal of one of the pixels at a distance from the gate driver chip greater than a predetermined distance is adjusted.

To be specific, combined with Table 1, the different values of the pixels in the first row to the third row after adjustment satisfy the following relationship: Δt11<Δt12<Δt13 , Δt21<Δt22<Δt23 , Δt31<Δt32<Δt33.

The different values of the pixels in the first column to the third column after adjusting satisfy the following relationship: Δt11<Δt21 <Δt31 , Δt12 <Δt22 <Δt32 , Δt13 <Δt23 <Δt33.

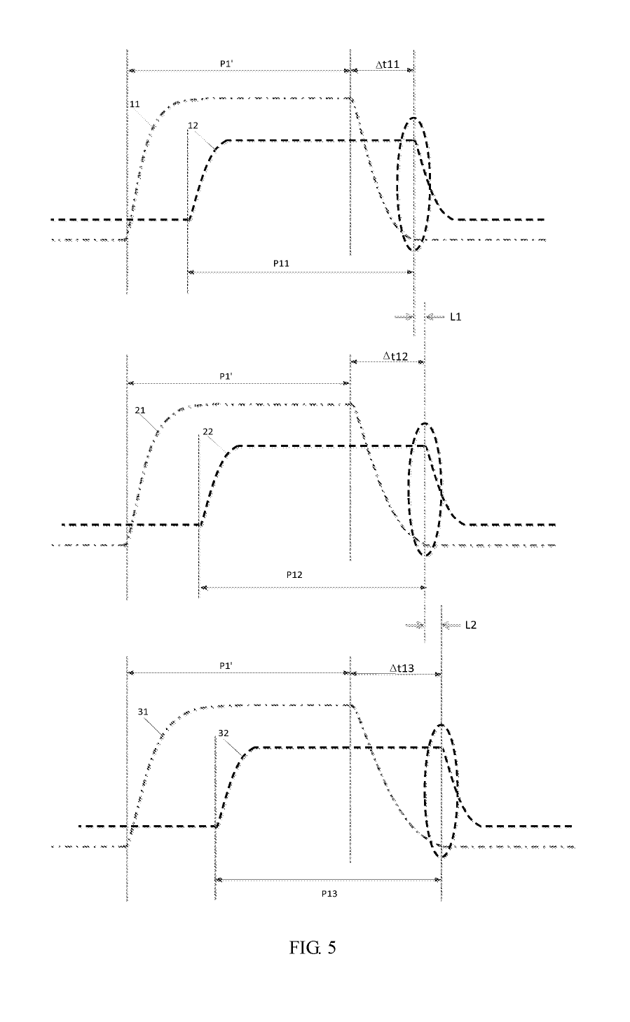

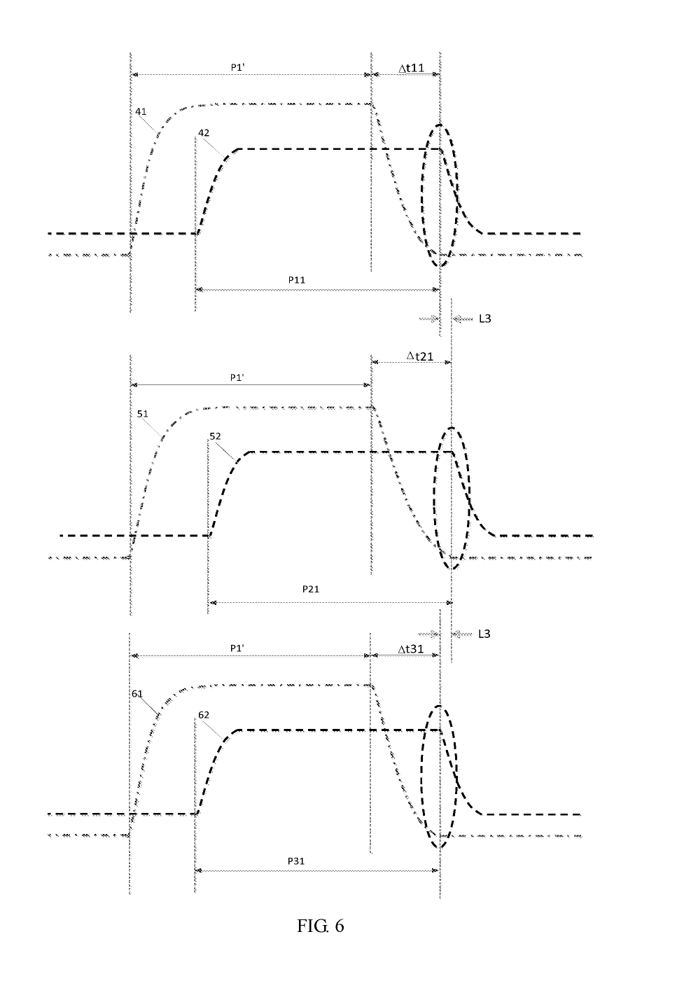

As shown in FIG. 5, P1′ represents the pulse of the scan signal. P11-P13 represents pulses of the data signals of three pixels in the first row after adjustment. After adjustment, the phase difference between the actual scan signal 11 and the actual data signal 12 of the pixel in the first row and the first column is ^{Δ}t11. The phase difference between the actual scan signal 21 and the actual data signal 22 of the pixel in the first row and the second column is ^{Δ}t12. The phase difference between the actual scan signal 31 and the actual data signal 32 of the pixel in the first row and the third column is ^{Δ}t13. After adjustment, the different value of the pixel in each row successively increases from left to right, and the different value of the pixel in each column successively increases from top to bottom.

Distance between the pixel in the first row and the second column and the gate driver chip, and distance between the pixel in the first row and the third column and the gate driver chip are both greater than distance between the pixel in first row and first column and the gate driver chip. Thus, the distance between the pixel in first row and first column and the gate driver chip is a predetermined distance. The pixel in the first row and the second column, and the pixel in the first row and the third column are provided for compensation. Namely, for the pixels in the first row and the second column, and in the first row and the third column, T′_{gf} is greater than T_{gd}.

In one embodiment, the specific compensation method is that the phase of the data signal of the pixel in the first row and the second column moves to the right by L1 (namely, it increases the phase of the data signal of the pixel), the phase of the data signal of the pixel in the first row and the third column moves to the right by L2+L1, further equalizing T_{gf} and T_{gd} along the vertical direction of the pixel in the first row and the second column, and equalizing T_{gf} and T_{gd} along the vertical direction of the pixel in the first row and third column. The driving signal compensation method of other pixels is similar, and so on.

In one embodiment, the specific compensation method is as follows: the phase of the scan signal of the pixel in the first row and the second column moves to the left by L1 (namely, it decreases the phase of the scan signal of the pixel), the phase of the data signal of the pixel in the first row and the third column moves to the left by L2+L1, further equalizing T_{gf} and T_{gd} along the horizontal direction of the pixel in the first row and the second column, and equalizing T_{gf} and T_{gd} along the horizontal direction of the pixel in the first row and third column.

In another embodiment, when the LCD panel comprises a first gate driver chip and a second gate driver chip opposite to the first gate driver chip. If the LCD panel is a double sided driver, the phase of the input scan signal of the pixel or the phase of the input data signal of the pixel that is at distances from the first gate driver chip and the second gate driver chip greater than the predetermined distance is adjusted.

To be specific, referring to table 1, when the first gate driver chip and the second gate driver chip drive, the different values of the pixels in the first column to the third rows after adjusting satisfy the following relationship: Δt11=Δt13<Δt12, Δt21=Δt23<Δt22, Δt31=Δt33<Δt32.

The different values of the pixels in the first column to the third rows after adjusting satisfy the following relationship: Δt11=Δt31<Δt21, Δt12=Δt32<Δt22, Δt13=Δt33<Δt23.

As shown in FIG. 6, P1′ represents the pulse of the scan signal. P11, P21, P31 represent pulses of the data signals of three pixels in the first column after adjustment. After adjustment, the phase difference between the actual scan signal 41 and the actual data signal 42 of the pixel in the first row and the first column is ^{Δ}t11. The phase difference between the actual scan signal 51 and the actual data signal 52 of the pixel in the first row and the second column is ^{Δ}t21. The phase difference between the actual scan signal 61 and the actual data signal 62 of the pixel in the first row and the third column is ^{Δ}t31. After adjustment, the phase difference of the pixel in each row successively increases from the middle to two sides, and the phase difference of the pixel in each column successively increases from the middle to two sides.

The distance between the pixel in the first row and the second column and the gate driver chip is greater than the distance between the pixel in the first row and the first column and the gate driver chip, and the distance between the pixel in the first row and the third column and the gate driver chip. Thus, the driving signal of the pixel in the first row and the second column are provided for compensation. Namely, for the pixels in the first row and the second column, T′_{gf} is greater than T_{gd}.

In one embodiment, the specific compensation method is as follows: the phase of the data signal of the pixel in the first row and the second column moves to the right by L3 (namely, it increases the phase of the data signal of the pixel) to equalize T_{gf} and T_{gd} along the vertical direction of the pixel in the first row and the second column. The driving signal compensation method of other pixels is similar, and so on.

In one embodiment, the specific compensation method is that: the phase of the scan signal of the pixel in the first row and the second column moves to the left by L3 (namely, it decreases the phase of the scan signal of the pixel) to equalize T_{gf} and T_{gd} along the horizontal direction of the pixel in the first row and the second column.

The embodiment of the present disclosure further provides a driving signal compensation device, where the driving signal compensation device comprises:
an obtaining module obtaining a first phase difference between an output scan signal and an output data signal of each pixel;
an adjusting module adjusting a phase of an input scan signal or a phase of an input data signal of the pixel according to the first phase difference, to equalize the first phase difference between the output scan signal and the output data signal of the pixel and a phase difference between the input scan signal and the input data signal of the pixel.

The adjusting module comprises an obtaining unit and an adjusting unit.

The obtaining unit obtains a difference value between the first phase difference and an initial phase difference of each pixel, and the initial phase difference is a phase difference between the input scan signal and the input data signal of the pixel.

The adjusting unit adjusts the phase of the input scan signal or the phase of the input data signal of the pixel according to the difference value.

The adjusting unit is configured to decrease the phase of the input scan signal of the pixel by the difference value when the first phase difference is greater than the initial phase difference.

The adjusting unit is configured so that the phase of the input scan signal of the pixel is decreased by the difference value, to equalize a phase difference along a vertical direction between the output scan signal and the output data signal of each pixel and a phase difference along the vertical direction between the input scan signal and the input data signal of the pixel.

The adjusting unit is configured to add the difference value to the phase of the input data signal of the pixel when the first phase difference is greater than the initial phase difference.

The adjusting unit is configured so that the difference value is added to the phase of the input data signal of the pixel, to equalize a phase difference along a horizontal direction between the output scan signal and the output data signal of each pixel and a phase difference along the horizontal direction between the input scan signal and the input data signal of the pixel.

The adjusting unit is configured to add a predetermined phase to the phase of the input data signal of each pixel.

When the LCD panel comprises the gate driver chip, the phase of the input scan signal or the phase of the input data signal of the pixel that is at a distance from the gate driver chip greater than a predetermined distance is adjusted.

When the LCD panel comprises the first gate driver chip and the second gate driver chip opposite the first gate driver chip, the phase of the input scan signal of the pixel or the phase of the input data signal of the pixel that is at distances from the first gate driver chip and the second gate driver chip greater than the predetermined distance is adjusted.

The driving signal compensation method and the driving signal compensation device of the present disclosure are used to adjust the phases of the input scan signal and the input data signal of the pixels at different position on of the

LCD panel, when the data signal switches during an actual driving process, the scan line completely turns off, further avoiding a false charging issue and improving the display.

It should be understood that the present disclosure has been described with reference to certain preferred and alternative embodiments which are intended to be exemplary only and do not limit the full scope of the present disclosure as set forth in the appended claims.

1. A driving signal compensation method, comprising:
obtaining a first phase difference between an output scan signal and an output data signal of each pixel;
obtaining a difference value between the first phase difference and an initial phase difference of each pixel, wherein the initial phase difference is a phase difference between an input scan signal and an input data signal of the pixel;
adjusting a phase of the input scan signal or a phase of the input data signal of the pixel according to the difference value to equalize the first phase difference between the output scan signal and the output data signal of the pixel and the initial phase difference between the input scan signal and the input data signal of the pixel;
when a liquid crystal display (LCD) panel comprises a gate driver chip, adjusting the phase of the input scan signal or the phase of the input data signal of the pixel that is at a distance from the gate driver chip greater than a predetermined distance.

2. The driving signal compensation method as claimed in claim 1, wherein the step of adjusting the phase of the input scan signal or the phase of the input data signal of the pixel according to the difference value further comprises:
decreasing the phase of the input scan signal of the pixel by the difference value when the first phase difference is greater than the initial phase difference.

3. The driving signal compensation method as claimed in claim 2, wherein the phase of the input scan signal of the pixel is decreased by the difference value, to equalize a phase difference along a vertical direction between the output scan signal and the output data signal of each pixel and a phase difference along the vertical direction between the input scan signal and the input data signal of the pixel.

4. The driving signal compensation method as claimed in claim 1, wherein the step of adjusting the phase of the input scan signal or the phase of the input data signal of the pixel according to the difference value further comprises:
adding the difference value to the phase of the input data signal of the pixel when the first phase difference is greater than the initial phase difference.

5. The driving signal compensation method as claimed in claim 4, wherein the difference value is added to the phase of the input data signal of the pixel, to equalize a phase difference along a horizontal direction between the output scan signal and the output data signal of each pixel and a phase difference along the horizontal direction between the input scan signal and the input data signal of the pixel.

6. The driving signal compensation method as claimed in claim 1, wherein the step of adjusting the phase of the input data signal of the pixel according to the difference value further comprises:
adding a predetermined phase to the phase of the input data signal of each pixel.

7. The driving signal compensation method as claimed in claim 1, when the LCD panel comprises a first gate driver chip and a second gate driver chip opposite to the first gate driver chip, adjusting the phase of the input scan signal of the pixel or the phase of the input data signal of the pixel that is at distances from the first gate driver chip and the second gate driver chip greater than the predetermined distance.

8. A driving signal compensation method, comprising:
obtaining a first phase difference between an output scan signal and an output data signal of each pixel;
adjusting a phase of an input scan signal of or a phase of an input data signal of the pixel according to the first phase difference, to equalize the first a phase difference between the output scan signal and the output data signal of the pixel and a phase difference between the input scan signal and the input data signal of the pixel.

9. The driving signal compensation method as claimed in claim 8, wherein the step of adjusting the phase of the input scan signal or the phase of the input data signal of the pixel according to the first phase difference further comprises:
obtaining a difference value between the first phase difference and an initial phase difference of each pixel, wherein the initial phase difference is a phase difference between the input scan signal and the input data signal of the pixel;
adjusting the phase of the input scan signal or the phase of the input data signal of the pixel according to the difference value.

10. The driving signal compensation method as claimed in claim 9, wherein the step of adjusting the phase of the input scan signal or the phase of the input data signal of the pixel according to the difference value further comprises:
decreasing the phase of the input scan signal of the pixel by the difference value when the first phase difference is greater than the initial phase difference.

11. The driving signal compensation method as claimed in claim 10, wherein the phase of the input scan signal of the pixel is decreased by the difference value, to equalize a phase difference along a vertical direction between the output scan signal and the output data signal of each pixel and a phase difference along the vertical direction between the input scan signal and the input data signal of the pixel.

12. The driving signal compensation method as claimed in claim 9, wherein the step of adjusting the phase of the input scan signal or the phase of the input data signal of the pixel according to the difference value further comprises:
adding the difference value to the phase of the input data signal of the pixel when the first phase difference is greater than the initial phase difference.

13. The driving signal compensation method as claimed in claim 12, wherein the difference value is added to the phase of the input data signal of the pixel, to equalize a phase difference along a horizontal direction between the adjusted output scan signal and the output data signal of each pixel and a phase difference along the horizontal direction between the adjusted input scan signal and the input data signal of the pixel.

14. The driving signal compensation method as claimed in claim 8, wherein the step of adjusting the phase of the input data signal of the pixel according to the difference value further comprises:
adding a predetermined phase to the phase of the input data signal of each pixel.

15. The driving signal compensation method as claimed in claim 8, when a liquid crystal display (LCD) panel comprises a gate driver chip, adjusting the phase of the input scan signal or the phase of the input data signal of the pixel that is at a distance from the gate driver chip greater than a predetermined distance.

16. The driving signal compensation method as claimed in claim 8, when the LCD panel comprises a first gate driver chip and a second gate driver chip opposite the first gate driver chip, adjusting the phase of the input scan signal of the pixel or the phase of the input data signal of the pixel that is at distances from the first gate driver chip and the second gate driver chip greater than the predetermined distance.

17. A driving signal compensation device, comprising:
an obtaining module obtaining a first phase difference between an output scan signal and an output data signal of each pixel; and
an adjusting module adjusting a phase of an input scan signal or a phase of an input data signal of the pixel according to the first phase difference, to equalize the first phase difference between the output scan signal and the output data signal of the pixel and a phase difference between the input scan signal and the input data signal of the pixel.

18. The driving signal compensation device as claimed in claim 17, wherein the adjusting module comprises an obtaining unit and an adjusting unit;
wherein the obtaining unit obtains a difference value between the first phase difference and an initial phase difference of each pixel, and the initial phase difference is a phase difference between the input scan signal and the input data signal of the pixel;
wherein the adjusting unit adjusts the phase of the input scan signal or the phase of the input data signal of the pixel according to the difference value.

19. The driving signal compensation device as claimed in claim 18, wherein the adjusting unit is configured to decrease the phase of the input scan signal of the pixel by the difference value when the first phase difference is greater than the initial phase difference.

20. The driving signal compensation device as claimed in claim 18, wherein the adjusting unit is configured to add the difference value to the phase of the input data signal of the pixel when the first phase difference is greater than the initial phase difference.
